(19) United States
(12) Patent Application Publication
(10) Pub. No.: US 2019/0221806 A1
(43) Pub. Date: Jul. 18, 2019

(54) HYBRID VEHICLE BATTERY WITH ELECTRODE/SEPARATOR HAVING NON-UNIFORM CONSTITUENT DISTRIBUTION TO PROLONG LIFE OF BATTERY CELLS

(71) Applicant: Ford Global Technologies, LLC, Dearborn, MI (US)

(72) Inventors: Rutooj D. DESHPANDE, Farmington Hills, MI (US); Venkataramani ANANDAN, Farmington Hills, MI (US)

(21) Appl. No.: 15/871,403

(22) Filed: Jan. 15, 2018

(51) Int. Cl. H01M 2/16; H01M 10/613; H01M 10/0525; H01M 10/6554; H01M 2/10

(52) U.S. Cl. CPC H01M 2/16; H01M 10/613; H01M 2220/20; H01M 10/6554; H01M 2/1077; H01M 10/0525

(57) ABSTRACT

An electrified vehicle battery pack includes a cold plate and a plurality of cells contacting the cold plate, each having a separator disposed between an anode and a cathode, at least one of the anode and the separator configured with a property gradient such that the property varies as a function of distance from the cold plate. The property may include particle size, particle loading or density, or porosity.

### TECHNICAL FIELD

This disclosure relates to a lithium battery having cell electrodes and/or separators with non-uniform constituent distribution features to prolong life of the battery cells.

### BACKGROUND

Battery charging and usage generally leads to an increase in battery cell temperatures as a result of battery internal resistance. High-capacity batteries, such as those used in hybrid vehicles, typically include hundreds of battery cells within a battery pack. As such, thermal management of the battery pack is used to meet desired battery life goals and minimize the effect of thermal variation on the performance and life of the battery pack. Various strategies for thermal management have been developed and may include various types of conductive and convective cooling, such as using a cold plate in contact with the battery cells and/or using liquid or air circulation with associated heat exchangers to reject heat, for example. Depending on the particular type of thermal management strategy employed, heat rejection from the periphery of the battery cells to the thermal management system may result in temperature gradients within individual cells or groups of cells. As vehicles transition to larger format cells to meet desired capacity and range goals, the more extreme temperature gradients within the cells and battery pack may present additional challenges.

### SUMMARY

In one or more embodiments, a lithium-ion battery pack includes a thermal management device and a plurality of battery cells in contact with the thermal management device with at least one of the battery cells including an anode or a separator having at least one of varying porosity, particle size, or particle loading, wherein the varying porosity, particle size, or particle loading varies based on distance from the thermal management device. The thermal management device may include a cold plate. The material property may include porosity with the porosity varying from more porous to less porous with increasing distance from the thermal management device. The material property may include particle size with the particle size varying from smaller particles to larger particles with increasing distance from the thermal management device.

Various embodiments may include a hybrid vehicle battery pack having a cold plate and a plurality of cells having a first surface contacting the cold plate, each cell including a separator disposed between an anode and a cathode, wherein at least one of the anode and the separator is configured with a material property gradient such that the material property varies based on distance from the cold plate. The material property may include porosity, which may vary from a higher value to a lower value with increasing distance from the cold plate. The separator may have a porosity that varies from more porous to less porous as distance from the cold plate increases. In one or more embodiments, the material property may include particle size of a component particle of the anode. The particle size may increase with increasing distance from the cold plate. Embodiments may include an anode having particle loading or density that increases with increasing distance from the cold plate. In at least one embodiment, the material property comprises porosity of the separator, the porosity varying from more porous to less porous with increasing distance from the cold plate. The battery pack may be a lithium-ion battery pack.

In one or more embodiments, a battery includes a thermal management device and a plurality of cells having at least one surface contacting the thermal management device, each cell having an anode, a separator, and a cathode. At least one of the anode and the separator comprises a material having a material property or component property that varies relative to distance from the thermal management device. The thermal management device may include a cold plate. The material property may include porosity of the anode or the separator, with porosity varying from more porous to less porous as distance from the thermal management device increases. The material or component property may include particle density of an anode material component.

Embodiments according to the disclosure may include one or more advantages. For example, battery cell designs that compensate for temperature gradients facilitate larger batteries with more cells and larger capacity while reducing or eliminating adverse performance associated with lithiation and associated lithium plating. Battery cells having an anode and/or separator with at least one property characteristic, such as particle size, particle loading or distribution, or porosity that varies with distance from a thermal management device reduces or eliminates the expected effects of temperature gradients within the cells.

### BRIEF DESCRIPTION OF THE DRAWINGS

FIG. 1 is a diagram illustrating a battery cell having an anode with a gradient porosity according to one or more embodiments;

FIG. 2 is a diagram illustrating a battery cell having an anode with a gradient particle size according to one or more embodiments;

FIG. 3 is a diagram illustrating a battery cell having an anode with gradient particle loading or density according to one or more embodiments;

FIGS. 4A and 4B illustrate a battery cell having an anode/cathode separator with gradient porosity according to one or more embodiments;

FIGS. 5A and 5B illustrate the effect of temperature gradients on battery cell lithiation in a prior art battery cell during charging; and

FIG. 6 illustrates reduction of lithiation variation in a battery cell having a separator with gradient porosity according to one or more embodiments relative to a baseline cell with a conventional separator.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Representative embodiments according to the present disclosure are described with reference to lithium-ion batteries having cells connected together within a battery pack, such as used in hybrid vehicles, for example. Although described with reference to lithium-ion cells and reducing variation of lithiation, those of ordinary skill in the art will recognized that one or more of the cell designs described herein may be used in other types of battery cells that may have various battery chemistries and physical configurations.

In lithium-ion cells, cell temperature tends to increase due to various factors such as joule heating, heat of reaction, entropic heat contribution, etc. Various thermal management strategies rely on extracting heat from the outer surface of the cell to keep the cell temperature within specified limits. The present inventors have recognized that heat extraction from the cell surface during operation and charging often results in a temperature gradient within the cell based on the distance from the thermal management device, such as a cold plate, circulating fluid, etc. Because various physicochemical processes such as ionic diffusion in the electrolyte, rate of reactions, rate of intercalation/deintercalation, etc. are highly temperature dependent, the temperature gradient within a cell may lead to inhomogeneous utilization of the electrode.

Various electrode materials, such as graphite, that have a relatively flat or linear Open Circuit Potential (OCP) curve as a function of the state-of-lithiation (SOL) experience more inhomogeneity in current distribution when subjected to temperature gradients. The relatively flat SOL vs. OCP curve provides a minimal voltage penalty associated with different states of lithiation at different locations of the same electrode. Because lithium ions more readily react at points of least transport resistance, this results in more lithiation of particles at locations of least resistance. Detailed electrochemical simulations for a graphite-based lithium-ion cell with a temperature gradient reveal that the temperature gradient significantly affects the electrode utilization, particularly during charging events including on-plug charging and regenerative braking. The warmer portions of the negative electrode experience much larger current density than the cooler portions of the electrode. This non-uniform current distribution may lead to non-uniform states of lithiation of the negative electrode along the temperature gradient direction. During certain charging events, the warmer part of the electrode may get filled completely even though the colder part of the electrode is at a much lower state of lithiation. In such a scenario, any additional current during this operation may result in lithium plating on the warmer part of the negative electrode due to lack of available reaction sites and inherent inhomogeneity in the current distribution.

The present inventors have recognized that higher utilization of the electrodes at the warmer part of the cell results from the associated lowered effective resistance at warmer temperatures. As such, embodiments according to the present disclosure vary electrode thickness, particle size distribution, and porosity distribution of the electrode and/or separator based on the expected temperature gradient during operation, particularly during charging events, to reduce or eliminate these effects. In addition to the representative embodiments illustrated in the Figures, other embodiments may include different strategies to provide an electrode having higher resistance in the warmer areas of the electrode based on configuration, positioning, and type of thermal management device used. For example, the electrode could have less electronic conducting material (such as carbon) at the warmer region of the electrode than the colder region. In another example, a positive temperature coefficient (PTC) material could be added to the warmer region of the electrode so that the effective resistance at the warmer region is increased during higher temperature operation.

FIG. 1 is a diagram illustrating a battery cell having an anode with a gradient porosity according to one or more embodiments. A hybrid vehicle battery pack 100 may include a plurality of individual battery cells 102 connected together, only one of which is shown. Each battery cell 102 includes electrodes that function as an anode 104 and a cathode 108 with a separator 106 disposed therebetween. Battery pack 100 may include a thermal management device, such as a cold plate 110. Other types of thermal management or cooling devices may be used alone or in combination based on conductive or convective cooling depending on the particular application and implementation. In the representative embodiment illustrated, cold plate 110 contacts a bottom surface 120 of the cell containing anode 104, separator 106, and cathode 108. In other embodiments, a cold plate may be provided in contact with a side surface and/or a top surface of the cell. In various embodiments, the closest surface of anode 102, separator 106, and cathode 108 may not actually contact the cell surface, and the cell surface may not actually contact the cold plate or other thermal management device. Those of ordinary skill in the art will recognize that the warmer areas or regions of the electrode during operation will be those areas that are farther from the thermal management device. In applications having air or liquid cooling, warmer areas of the electrodes may be identified based on the fluid dynamics, such as may be obtained by corresponding simulations or measurements, for example. Similarly, some battery pack designs may include temperature gradients across groups of cells in addition to individual cell temperature gradients. Those of ordinary skill in the art will recognize that the teachings of this disclosure may be applied across groups of battery cells within a battery pack alone or in combination with application to individual battery cells.

The present inventors have recognized that higher utilization of the electrodes at the warmer part of cell results from the lowered effective resistance at warmer temperatures. As such, various embodiments vary material or component properties such as electrode thickness, particle size, porosity, etc. along the temperature gradient direction to compensate for the reduced cooling efficiency of the thermal management device at particular locations of the electrode or particular locations of cells within the battery pack. As such, embodiments according to the disclosure reduce or eliminate lithium plating of cells or electrodes subjected to temperature gradients.

As illustrated in the embodiment of FIG. 1, cell 102 includes an electrode design for anode 104 that includes higher porosity 130 in the part of negative electrode or anode 104 that is expected to be at lower temperature, and lower porosity 140 in the part of anode 104 that is expected to be at a higher temperature. This results in decreased effective resistance of the colder part of anode 104 closer to cold plate 110 so that it is closer to the effective resistance of the warmer part of the anode. As shown in FIG. 1, the porosity of anode 104, a material property, varies as a function of distance from thermal management device or cold plate 110 with high porosity or more porous closer to cold plate 110 and lower porosity or less porous farther from cold plate 110. Stated differently, electrode 104 has a porosity gradient based on distance from the thermal management device.

As described above, the direction or shape of the gradient may depend on the location of the thermal management or cooling device relative to the electrode. Some applications may incorporate thermal management devices that are configured or positioned relative to multiple surfaces of the cell or of a group of cells. For example, in a side-cooled thermal management design, the electrodes at the center of the cell would experience warmer temperatures than the side of cell. In these arrangements, the inner portions of the electrode would have lower porosity (i.e. be less porous) than the outer portion of the cell. Similarly, applications that have thermal management devices on the top and bottom of the cells would incorporate a material property gradient that varies from the top toward the center, and from the bottom toward the center. Using porosity as a representative material property, porosity would decrease from higher porosity at the bottom to lower porosity at the center of the electrode, and then increase from lower porosity at the center of the electrode to higher porosity at the top of the electrode.

The gradient material component or property may increase or decrease in a generally continuous fashion, either linearly or non-linearly. Alternatively, the property may increase or decrease in a step-wise manner with a first region having a first property, component, or characteristic, with an adjacent region having an increased property, component, or characteristic, etc. For example, using porosity as a representative material property, a first region may have a first porosity, with an adjacent region having a second porosity, etc.

Although described with reference to a hybrid vehicle battery pack, those of ordinary skill in the art will recognize that one or more embodiments may be applied to various battery applications and types of batteries and are not limited to a lithium-ion battery or a hybrid vehicle battery pack.

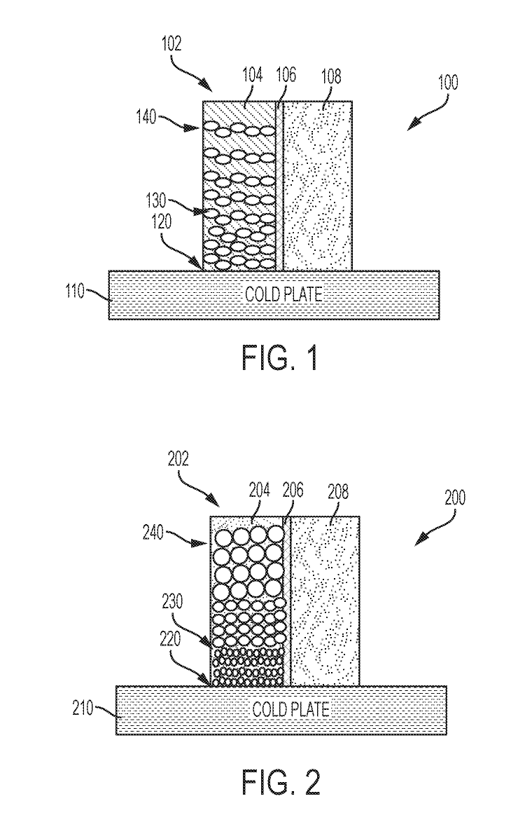

FIG. 2 is a diagram illustrating a battery cell having an anode with a gradient particle size according to one or more embodiments. A hybrid vehicle battery pack 200 may include a plurality of individual battery cells 202 connected together, only one of which is shown. Each battery cell 202 includes electrodes that function as an anode 204 and a cathode 208 with a separator 206 disposed therebetween. Battery pack 200 may include a thermal management device, such as a cold plate 210. Other types of thermal management or cooling devices may be used alone or in combination based on conductive or convective cooling as previously described. In the representative embodiment illustrated, cold plate 210 contacts a bottom surface of the cells 220 containing anode 204, separator 206, and cathode 208. In other embodiments, a cold plate may be provided in contact with a side surface and/or a top surface of the cell or groups of cells, for example.

As illustrated in the embodiment of FIG. 2, cell 202 includes an electrode design for anode 204 that includes smaller particles 230 in the part of negative electrode or anode 204 that is expected to be at lower temperature (closer to cold plate 210), and larger particles 240 in the part of anode 204 that is expected to be at a higher temperature (farther from cold plate 210). This results in decreased effective resistance of the colder part of anode 204 closer to cold plate 210 so that it is closer to the effective resistance of the warmer part of the anode 204. As shown in FIG. 2, the particle size of particles within anode 204, a material property, varies as a function of distance from thermal management device or cold plate 210 with smaller particles closer to cold plate 210 and larger particles farther from cold plate 210. Stated differently, electrode 204 has a particle size gradient based on distance from the thermal management device. The particle size gradient may vary depending on the particular thermal management device and placement as previously described with respect to porosity in FIG. 1.

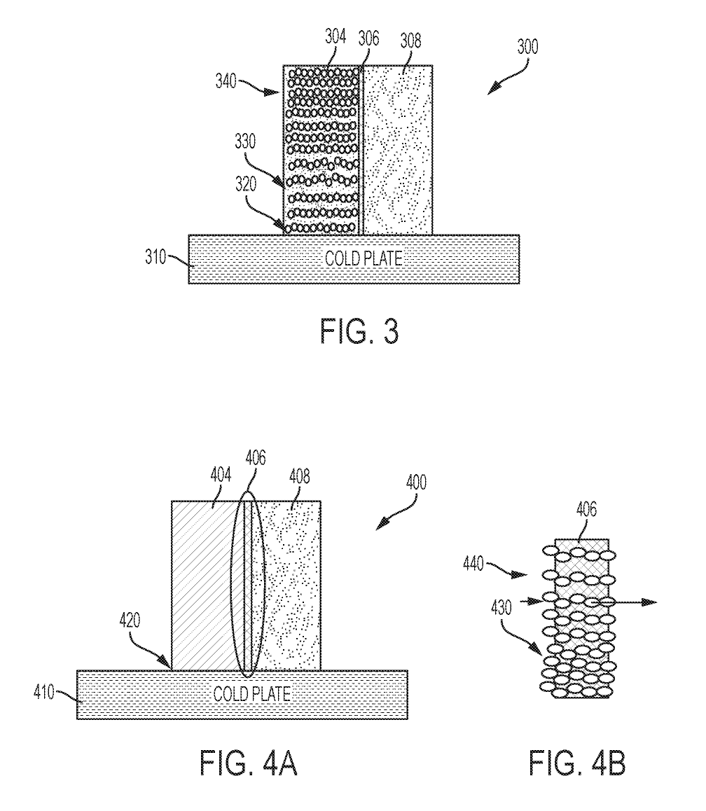

FIG. 3 is a diagram illustrating a battery cell having an anode with gradient particle loading or density according to one or more embodiments. A hybrid vehicle battery pack 300 may include a plurality of individual battery cells 302 connected together, only one of which is shown. Each battery cell 302 includes electrodes that function as an anode 304 and a cathode 308 with a separator 306 disposed therebetween. Battery pack 300 may include a thermal management device, such as a cold plate 310. Other types of thermal management or cooling devices may be used alone or in combination based on conductive or convective cooling as previously described. In the representative embodiment illustrated, cold plate 310 contacts a bottom surface 320 of one or more cells containing an anode 304, separator 306, and cathode 308. In other embodiments, a cold plate may be provided in contact with a side surface and/or a top surface of one or more cells or groups of cells.

As illustrated in the embodiment of FIG. 3, cell 302 includes an electrode design for anode 304 that includes less particle loading or lower density of particles 330 in the part of negative electrode or anode 304 that is expected to be at lower temperature (closer to cold plate 310), and higher particle loading or density 340 in the part of anode 204 that is expected to be at a higher temperature (farther from cold plate 310). This results in decreased effective resistance of the colder part of anode 304 closer to cold plate 310 so that it is closer to the effective resistance of the warmer part of the anode 304. As shown in FIG. 3, the particle density or loading density within anode 304, a material property, varies as a function of distance from thermal management device or cold plate 310 with a lower density or lower loading closer to cold plate 310 and higher density or higher loading farther from cold plate 310. Stated differently, electrode 304 has a particle density or loading gradient based on distance from the thermal management device. The particle density or loading gradient may vary depending on the particular thermal management device and placement as previously described with respect to porosity in FIG. 1. This results in decreasing the effective utilization of the warmer part of the electrode to better match the utilization of colder part of the electrode.

FIGS. 4A and 4B illustrate a battery cell having an anode/cathode separator with gradient porosity according to one or more embodiments. FIG. 4B is an enlarged depiction of the electrolyte separator to better illustrate the gradient porosity. A hybrid vehicle battery pack 400 may include a plurality of individual battery cells 402 connected together, only one of which is shown. Each battery cell 402 includes electrodes that function as an anode 404 and a cathode 408 with an electrolyte separator 406 disposed therebetween. Battery pack 400 may include a thermal management device, such as a cold plate 410. Other types of thermal management or cooling devices may be used alone or in combination based on conductive or convective cooling as previously described. In the representative embodiment illustrated, cold plate 410 contacts a bottom surface 420 of one or more cells containing an anode 404, electrolyte separator 406, and cathode 408. In other embodiments, a cold plate may be provided in contact with a side surface and/or a top surface of one or more cells or groups of cells.

As illustrated in the embodiment of FIGS. 4A and 4B, cell 402 includes an electrolyte separator 406 that includes a higher porosity or more porous region 430 in the part of the electrolyte separator 406 that is expected to be at lower temperature (closer to cold plate 410), and lower porosity or less porous region 440 in the part of electrolyte separator 406 that is expected to be at a higher temperature (farther from cold plate 410). As shown in FIGS. 4A and 4B, the porosity of the electrolyte separator, a material property or characteristic, varies as a function of distance from thermal management device or cold plate 410 with a higher porosity closer to cold plate 410 and lower porosity farther from cold plate 410. Stated differently, electrolyte separator 406 has a porosity gradient based on distance from the thermal management device. The porosity gradient may vary depending on the particular thermal management device and placement as previously described with respect to porosity in FIG. 1. The illustrated separator porosity gradient decreases the effective resistance in the colder part of the electrode to match that the warmer part of the cell.

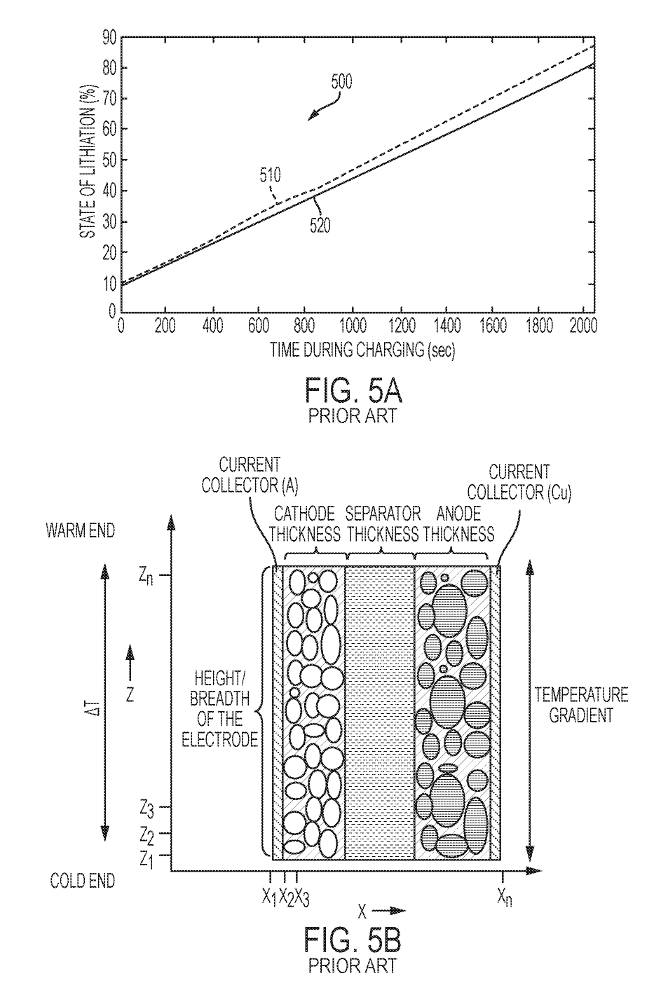

FIGS. 5A and 5B illustrate the effect of temperature gradients on battery cell lithiation in a prior art battery cell during charging, such as on-plug charging or during regenerative braking. Graph 500 was generated based on simulated charging of a hypothetical graphite-NMC (Lithium Nickel Manganese Cobalt Oxide) battery cell with electrode dimensions specified in the table below and generally illustrated in FIG. 5B.

| | Positive | Negative | Electrolyte |
|---|---|---|---|
| | Electrode | Electrode | Separator |
| Material | NMC333 | Graphite | PP/PE |
| Thickness (μm) | 10 | 12 | 22 |
| Porosity | 28% | 33% | 41% |
| Current Collector | 10 μm Al | 16 μm Cu | |

These cells are assumed to be cooled through a cold plate placed at the bottom of the cells. The cells are charged at a 1.5 C rate. During the entire charge operation, the cell is subjected to a constant 7° C. temperature gradient from top to bottom of the cell with the bottom being colder (with an average cell temperature of 25° C. As shown by the plot 500 in FIG. 5A, line 510 demonstrates that negative electrode particles closer to the separator near the warmer end of the cell are lithiated at a higher rate than particles located at the colder end as represented by line 520. If the charging had continued further, line 510 would have reached 100% state of lithiation earlier than the line 520 increasing the possibility of lithium plating at the warmer end of the electrode. Depending upon the various electrode characteristics and charging parameters, such as thickness, porosity, rate of charging, gradient in temperature, and average temperature, the difference between line 510 and line 520 may increase. Additionally, the non-uniform utilization of electrodes leads to more capacity loss as compared to electrodes that are uniformly utilized. Probability of lithium plating is much higher during charging due to inhomogeneous current distribution on the negative electrode. This may adversely affect the life of the cells. As such, various embodiments according to the disclosure provide a gradient of a material property or characteristic to provide more uniform utilization of the electrodes to reduce or eliminate localized lithiation and lithium plating.

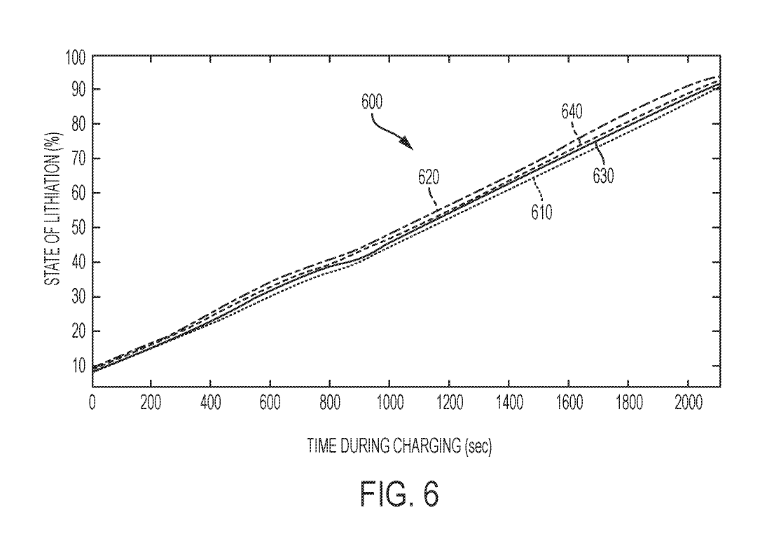

FIG. 6 illustrates reduction of lithiation variation in a battery cell having a separator with gradient porosity according to one or more embodiments relative to a baseline cell with a conventional separator. Plot 600 illustrates simulations to compare the state of lithiation of different locations in the negative electrode for a cell with a temperature gradient (7° C. from top to bottom) during 1 C charging. Lines 610 and 620 represent a baseline or conventional battery cell where the electrolyte separator has uniform porosity (41% porous) from top to bottom. Line 610 represents the portion of the cell closer to the cold plate, while line 620 represents the portion of the cell farther away from the cold plate. As illustrated, the temperature gradient results in more lithiation in the warmer part of the cell as represented by line 620 relative to the colder part of the cell as represented by line 610. As previously described, non-uniform utilization of the electrode may lead to lithium plating at the top portion in certain charging conditions.

Lines 630 and 640 were generated by charging simulations for a cell that has an electrolyte separator with a porosity gradient, such as described and illustrated with respect to FIGS. 4A and 4B. Line 630 represents a cooler region closer to the cold plate or other thermal management device, while line 630 represents a warmer region farther from the cold plate or other thermal management device. The top of the separator has a porosity of 31% porous, while the bottom of the separator has a porosity of 51% porous, such that the average porosity is 41%, similar to that in the baseline case. As illustrated by plot 600, lines 630 and 640 corresponding to a battery cell having a gradient porosity separator has more uniform distribution of state of lithiation from top to bottom relative to a cell without a gradient porosity separator as represented by lines 610 and 620 with the same temperature gradient and average porosity.

As those of ordinary skill in the art will recognize, various embodiments as illustrated and described herein may include one or more advantages associated with battery cell designs that compensate for temperature gradients, such as facilitating larger batteries with more cells and larger capacity while reducing or eliminating adverse performance associated with lithiation and lithium plating. Battery cells having an anode and/or separator with at least one property characteristic, such as particle size, particle loading or distribution, or porosity that varies with distance from a thermal management device reduce or eliminate the expected effects of temperature gradients within the cells.

While representative embodiments are described above, it is not intended that these embodiments describe all possible forms of the claimed subject matter. The words used in the specification are words of description rather than limitation, and it is understood that various changes may be made without departing from the spirit and scope of the disclosure. Additionally, the features of various implementing embodiments may be combined to form further embodiments that are not explicitly described or illustrated. While various embodiments may have been described as providing advantages or being preferred over other embodiments or prior art implementations with respect to one or more desired characteristics, as one of ordinary skill in the art is aware, one or more features or characteristics may be compromised to achieve desired overall system attributes, which depend on the specific application and implementation. These attributes include, but are not limited to: cost, strength, durability, life cycle cost, marketability, appearance, packaging, size, serviceability, weight, manufacturability, ease of assembly, etc. Embodiments described as less desirable than other embodiments or prior art implementations with respect to one or more characteristics are not necessarily outside the scope of the disclosure and may be desirable for particular applications.

What is claimed is:

1. An electrified vehicle battery pack, comprising:
a cold plate; and
a plurality of cells contacting the cold plate, each comprising:
a separator disposed between an anode and a cathode, wherein at least one of the anode and the separator is configured with a material property gradient such that the material property varies based on distance from the cold plate.

2. The electrified vehicle battery pack of claim 1 wherein the material property comprises porosity.

3. The electrified vehicle battery pack of claim 2 wherein the porosity varies from a higher value to a lower value with increasing distance from the cold plate.

4. The electrified vehicle battery pack of claim 1 wherein the separator has a porosity that varies from a higher value to a lower value with increasing distance from the cold plate.

5. The electrified vehicle battery pack of claim 1 wherein the material property comprises particle size.

6. The electrified vehicle battery pack of claim 5 wherein the particle size increases with increasing distance from the cold plate.

7. The electrified vehicle battery pack of claim 1 wherein the material property comprises particle loading.

8. The electrified vehicle battery pack of claim 7 wherein the particle loading increases with increasing distance from the cold plate.

9. The electrified vehicle battery pack of claim 1 wherein the material property comprises porosity of the separator, the porosity varying from more porous to less porous with increasing distance from the cold plate.

10. The electrified vehicle battery pack of claim 1 wherein the material property comprises electrical resistance.

11. A battery comprising:
a thermal management device; and
a plurality of cells having at least one surface contacting the thermal management device, each having an anode, a separator, and a cathode, wherein at least one of the anode and the separator comprises a material having a material property that varies relative to distance from the thermal management device.

12. The battery of claim 11 wherein the thermal management device comprises a cold plate.

13. The battery of claim 11 wherein the material property comprises porosity of the anode.

14. The battery of claim 11 wherein the material property comprises particle size of an anode material component.

15. The battery of claim 11 wherein the material property comprises particle density of an anode material component.

16. The battery of claim 11 wherein the material property comprises porosity of the separator.

17. The battery of claim 11 wherein the material property comprises porosity and wherein the porosity varies from more porous to less porous as distance from the thermal management device increases.

18. A lithium-ion battery pack comprising:
a thermal management device;
a plurality of battery cells in contact with the thermal management device, at least one of the battery cells comprising an anode or a separator having at least one of varying porosity, particle size, or particle loading, wherein the varying porosity, particle size, or particle loading varies based on distance from the thermal management device.

19. The lithium-ion battery pack of claim 18 having varying porosity and wherein the porosity varies from more porous to less porous with increasing distance from the thermal management device.

20. The lithium-ion battery pack of claim 18 having varying particle size, wherein the particle size varies from a smaller particle size to a larger particle size with increasing distance from the thermal management device.
